(19) United States
(12) Patent Application Publication
(10) Pub. No.: US 2023/0410224 A1
(43) Pub. Date: Dec. 21, 2023

(54) TICKETING, MEDIA ORGANIZATION AND SOCIAL MEDIA PLATFORM

(71) Applicant: GENESIS BLOCKCHAIN STUDIOS, Irvine, CA (US)

(72) Inventors: Lawrence YEH, Irvine, CA (US); Victor OUYANG, Temple City, CA (US)

(21) Appl. No.: 18/335,396

(22) Filed: Jun. 15, 2023

Related U.S. Application Data
(60) Provisional application No. 63/366,572, filed on Jun. 17, 2022.

(51) Int. Cl. G06Q 50/00

(52) U.S. Cl. CPC G06Q 50/01

(57) ABSTRACT

A self-service ticketing platform can connect user memories (photos, videos, and the like) to events and event tickets. The platform can permit users to store their event-driven memories privately, share them with selective users or share them publicly. Autographs and custom messages can be applied to memories, not limited to photos and videos, to create unique memorabilia non-fungible tokens (NFTs). For every event, the platform can provide an engagement feature defined as “Bubbles”, which allow for social interaction pre-event, during the event in real time and post event. For designated events, Bubbles can be separated into “Pods”, which can be defined based on user interests, seating location, age, demographics, gender, or the like. The platform can promote future events based on the past ticket purchases and past stored memories of the user.

### CROSS-REFERENCE TO RELATED APPLICATIONS

This application claims the benefit of U.S. provisional patent application number 63/366,572, filed Jun. 17, 2022, the contents of which are herein incorporated by reference.

### BACKGROUND OF THE INVENTION

### 1. Field of the Invention

Embodiments of the invention relate generally to multi-purpose computing systems, software and methods for using the same. More particularly, embodiments of the invention relate to a ticketing, media organization and social media platform where a user can purchase tickets; can link photos, videos and other media related to the ticketed event to the purchased ticket; and can interact with other ticket purchasers before, during and after a performance.

### 2. Description of Prior Art and Related Information

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

People often enjoy going out to see shows, plays, concerts or the like. Most venues today also permit people to take pictures during performances. Such photos are often shared with families and friends or even placed on one or more social media platforms. However, there is currently no way to connect with others that are going to see the same performance or that previously was at the same performance. Further, there is no way to store, organize and share media related to the performance.

In view of the foregoing, there is a need for an improved system that addresses many of the limitations of conventional aspects of ticket purchase, event memory organization and social interactions with others.

### SUMMARY OF THE INVENTION

Embodiments of the present invention provide a computer-based platform for providing a user with interaction with events, other users and memories of past events, the platform permitting a user to perform functions comprising viewing a memories page of a future event for which the user has purchased a ticket or of a past event for which the user has attended, the memory page including engagement bubbles, the engagement bubbles identifying other users that are attending the future event or that have attended the past event, the memories page including media taken by the user or by the other users of the past event; viewing a user profile by clicking on a user displayed in the engagement bubbles; and providing a messaging function by clicking on a chat icon displayed in the user profile.

Embodiments of the present invention further provide a computer-based platform for providing a user with interaction with events, other users and memories of past events, the platform permitting a user to perform functions comprising viewing one or more geo-fenced areas on a map (also referred to as zones or communities, for example), the one or more geo-fenced areas corresponding to a venue, a public space, or a privately defined area, for example; permitting the user to post or view media related to a selected one of the one or more geo-fenced areas, wherein the media includes text, photos, videos or livestreams; and regulating access to media within the selected one of the geo-fenced areas based on at least one of a geolocation of the user or a predetermined permission for the selected one of the geo-fenced areas.

Embodiments of the present invention further provide a computer-based platform for providing a user with interaction with events, other users and memories of past events, the platform permitting a user to perform functions comprising viewing a memories page of a future event for which the user has purchased a ticket or of a past event for which the user has attended, the memory page including engagement bubbles, the engagement bubbles identifying other users that are attending the future event or that have attended the past event, the memories page including media taken by the user or by the other users of the past event; linking media of an attended event to a ticket purchased to the event; and receiving memorabilia of the attended event and saving the memorabilia to the memories page of the user for the attended event.

Embodiments of the present invention also provide a computer-based platform for providing a user with interaction with events, other users and memories of past events, the platform permitting a user to perform functions comprising listing future events and permitting a user to purchase a ticket to a selected one of the future events; viewing a memories page of a future event for which the user has purchased a purchased ticket or of a past event for which the user has attended, the memory page including engagement bubbles, the engagement bubbles identifying other users that are attending the future event or that have attended the past event, the memories page including media taken by the user or by the other users of the past event; linking media of an attended event to a ticket purchased to the event; receiving memorabilia of the attended event and saving the memorabilia to the memories page of the user for the attended event; viewing a user profile by clicking on a user displayed in the engagement bubbles; and providing a messaging function by clicking on a chat icon displayed in the user profile.

These and other features, aspects and advantages of the present invention will become better understood with reference to the following drawings, description and claims.

### BRIEF DESCRIPTION OF THE DRAWINGS

Some embodiments of the present invention are illustrated as an example and are not limited by the figures of the accompanying drawings, in which like references may indicate similar elements.

FIG. 1 illustrates a representation of how aspects of the present invention relate to conventional ticketing processes;

FIG. 2 illustrates a screen shot showing an exemplary home page for a user operating the system according to an embodiment of the present invention;

FIG. 3 illustrates a screen shot showing additional information available to a user on the home page of FIG. 2;

FIG. 4 illustrates a screen shot showing a memories page available to a user accessing the system according to an exemplary embodiment of the present invention;

FIG. 5 illustrates a screen shot showing how the memories page of FIG. 4 can periodically change among different memories of a selected event;

FIG. 6 illustrates a screen shot showing how a user can navigate to see memories of different events;

FIG. 7 illustrates a screen shot showing how a user can access more memories from other users for the same event;

FIG. 8 illustrates a screen shot showing an additional memory page available on the system according to an embodiment of the present invention;

FIG. 9 illustrates a screen shot showing how a user can click into a user bubble to access a partial profile of the user;

FIG. 10 illustrates how a user can access a chat or messaging system to communicate with a user;

FIG. 11 illustrates a screen shot showing a detailed view of upcoming events that are accessible to the user;

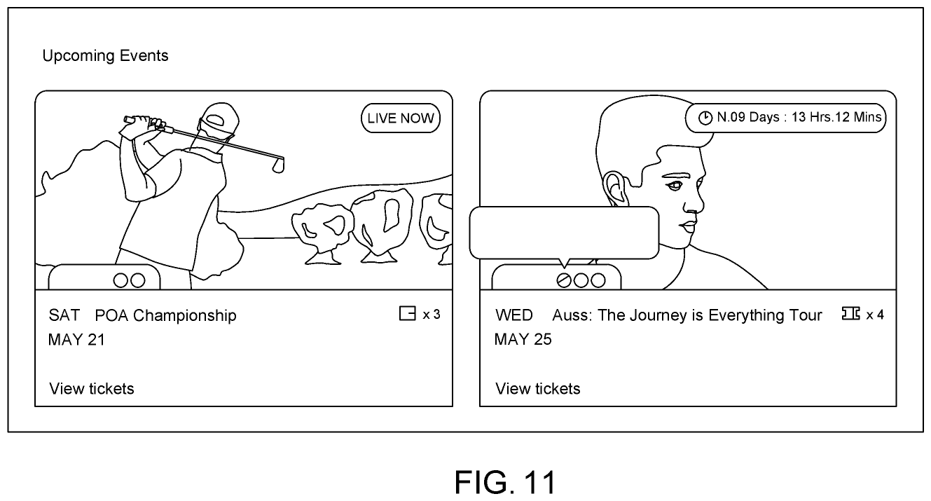

FIG. 12 illustrates a screen shot showing tickets purchased by the user under the “my events” tab of the platform;

FIG. 13 illustrates a screen shot of a mini-map of a golf course, showing a live view of users currently playing on the course;

FIG. 14 illustrates a screen shot of memorabilia, in the form of an autograph, applied to a user memory, in the form of a photo taken during an event;

FIG. 15 illustrates a screen shot showing additional memorabilia applied to memories;

FIG. 16 illustrates a screen shot showing a user's location on a map as well as nearby zones, indicating that the user is within a certain zone;

FIG. 17 illustrates a screen shot showing a discover zones view, where a user can see nearby zones and click into these zones to see their details; and

FIG. 18 illustrates a screen show showing a messaging system provided to users within a given zone.

Unless otherwise indicated illustrations in the figures are not necessarily drawn to scale.

The invention and its various embodiments can now be better understood by turning to the following detailed description wherein illustrated embodiments are described. It is to be expressly understood that the illustrated embodiments are set forth as examples and not by way of limitations on the invention as ultimately defined in the claims.

### DETAILED DESCRIPTION OF THE PREFERRED EMBODIMENTS AND BEST MODE OF INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

As is well known to those skilled in the art, many careful considerations and compromises typically must be made when designing for the optimal configuration of a commercial implementation of any system, and in particular, the embodiments of the present invention. A commercial implementation in accordance with the spirit and teachings of the present invention may be configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

A “computer” or “computing device” may refer to one or more apparatus and/or one or more systems that are capable of accepting a structured input, processing the structured input according to prescribed rules, and producing results of the processing as output. Examples of a computer or computing device may include: a computer; a stationary and/or portable computer; a smart phone; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

“Software” or “application” may refer to prescribed rules to operate a computer. Examples of software or applications may include code segments in one or more computer-readable languages; graphical and or/textual instructions; applets; pre-compiled code; interpreted code; compiled code; and computer programs.

The example embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software program code for carrying out operations for aspects of the present invention can be written in any combination of one or more suitable programming languages, including an object oriented programming languages and/or conventional procedural programming languages, and/or programming languages such as, for example, Hypertext Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, Smalltalk, Python, Perl, UNIX Shell, Visual Basic or Visual Basic Script, Virtual Reality Markup Language (VRML), ColdFusion™ or other compilers, assemblers, interpreters or other computer languages or platforms.

Computer program code for carrying out operations for aspects of the present invention may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). The program code may also be distributed among a plurality of computational units wherein each unit processes a portion of the total computation.

The Internet is a worldwide network of computers and computer networks arranged to allow the easy and robust exchange of information between computer users. Hundreds of millions of people around the world have access to computers connected to the Internet via Internet Service Providers (ISPs). Content providers (e.g., website owners or operators) place multimedia information (e.g., text, graphics, audio, video, animation, and other forms of data) at specific locations on the Internet referred to as webpages. Web sites comprise a collection of connected, or otherwise related, webpages. The combination of all the web sites and their corresponding webpages on the Internet is generally known as the World Wide Web (WWW) or simply the Web.

Although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

It will be readily apparent that the various methods and algorithms described herein may be implemented by, e.g., appropriately programmed computers and computing devices. Typically, a processor (e.g., a microprocessor) will receive instructions from a memory or like device, and execute those instructions, thereby performing a process defined by those instructions. Further, programs that implement such methods and algorithms may be stored and transmitted using a variety of known media.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The term “computer-readable medium” as used herein refers to any medium that participates in providing data (e.g., instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random-access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASHEEPROM, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth, TDMA, CDMA, 3G, 4G, 5G and the like.

Embodiments of the present invention may include apparatuses for performing the operations disclosed herein. An apparatus may be specially constructed for the desired purposes, or it may comprise a device selectively activated or reconfigured by a program stored in the device.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory or may be communicated to an external device so as to cause physical changes or actuation of the external device.

Broadly, embodiments of the present invention provide a self-service ticketing platform that connects user memories (photos, videos, and the like) to events. The platform can permit users to store their event-driven memories privately, share them with selective users or share them publicly. Autographs and custom messages can be applied to photos and videos to create memorabilia non-fungible tokens (NFTs). For every event, the platform can provide an engagement feature defined as “Bubbles”, which allow for social interaction pre-event, during the event in real time and post event. For designated events, Bubbles can be separated into “Pods”, which can be defined based on user interests, seating location, age, demographics, gender, or the like. The platform can promote future events based on the past ticket purchases and past stored memories of the user.

As discussed in greater detail below with respect to the Figures, the self-service ticketing platform can permit a user to purchase a ticket to an event. The ticket purchased can be an NFT ticket, however, if the user purchased a ticket elsewhere, the platform could permit a user to use such tickets in the platform. For example, if the ticket is a digital ticket and an NFT ticket, the user will be able to transfer the NFT ticket by sending it to the wallet address on the platform. If the ticket is a digital ticket and not an NFT ticket, the platform will have a function to receive a transfer of the digital ticket (non-NFT), and convert it to an NFT ticket. The platform can further support secondary ticket sales, where users will be able to purchase tickets and resell the tickets on the platform.

The event could be any type of event, from concerts, plays, sporting events, community events, a participation event (such as a round of golf), or the like. Each user of the platform can connect memories to their event ticket. Such memories can include photos, videos, recordings or the like. These memories can be marked private, shared with selected users or shared to all users.

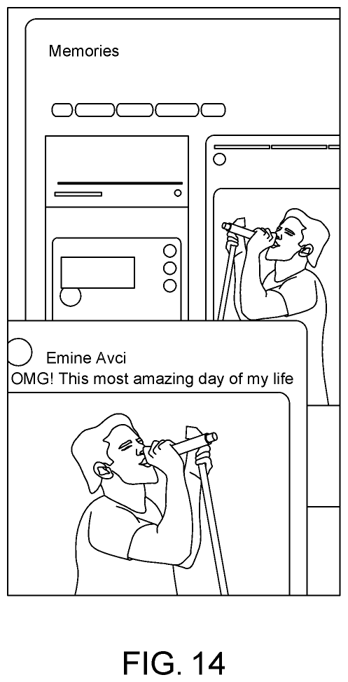

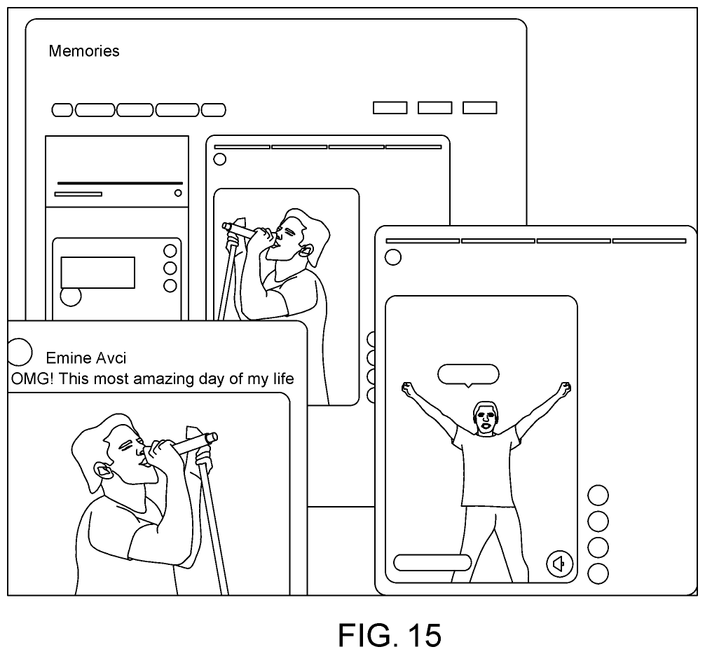

In some embodiments, autographs and custom messages can be applied to the memories to create memorabilia NFTs. For example, a user can take a picture of an artist's performance and store it as a memory on the platform. The user can then overlay the memory, such as a picture or a video, with the artist's digital autograph. This autograph can be delivered to all or selected audience members of the event. The autograph may be delivered to the user via airdrop or other methods. For example, an artist may perform a benefit concert where, for paying a premium, the concert-attendee provides a donation and would receive an autograph of the performer to overlay on their digital ticket or any other type of user-saved memory from the event. Thus, a user could apply the autograph NFT provided by an artist to a photo of the artist taken during the event. In some embodiments, the performer may provide a predetermined number of autograph NFTs that may be distributed in various manners, such as randomly. FIGS. 14 and 15 illustrate examples of such memorabilia that may be obtained via the platform according to embodiments of the present invention.

For every event, there will be an engagement feature defined as “Bubbles”. Bubbles allow for social interaction before, during (live and in real time), and after an event. For designated events, such as large-scale events, Bubbles can be separated into “Pods”, which can be custom-defined based on user interests, seating location, age, demographics, gender, or the like. The Bubble can have an event map (stadium seat map, concert hall seat map, golf course map, or the like) that allows event attendees to locate each other during the live event or determine a seat location of the attendee after the event. Knowing such location information after the event may be useful when providing messaging communication via the platform to other users to discuss the event.

As mentioned above, there can be three different stages of Bubbles engagement. First, a pre-event bubble engagement can be provided where ticket holders will be able to interact with other ticket holders prior to the event. Second, a during-event bubble engagement can be provided where event attendees can view shared memories and content in real-time by scrolling on the “seat map” or “location”. Further, members of the platform may be able to locate each other during the event, if desired. Third, a post-event bubble engagement can be provided where ticket holders will be able to interact and share memories with other ticket holders after the event.

In some embodiments, the platform can promote upcoming events using memories from past events, past ticket purchases, user comments, or the like.

In some embodiments, users may be permitted to purchase a Founders Club” NFT. The Founders Club users can be provided additional access, such as presale access to events, preferred event seating, discounts on tickets and the like. In some embodiments, Founders Club users can be involved in the platform decentralized autonomous organization (DAO), which allows users to vote on important decisions related to the platform. In some embodiments, Founders Club users can be able to earn revenue generated from the platform. In some embodiments, Founders Club users can be able to rent out their Founders Club pass to generate additional revenue. Typically, Founders Club pass rental will have expiration date, in which the Founders Club pass will be returned to the owner.

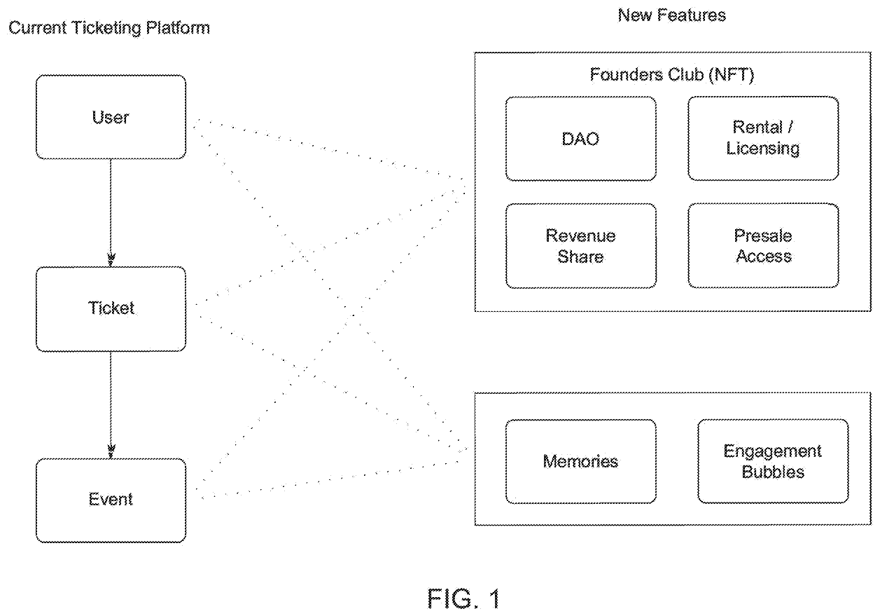

Referring now to FIG. 1, conventional ticketing platforms, as illustrated on the left side of the figure, interact with the user to provide a ticket to an event. There is no interaction between the user and the platform before, during or after the event. To the contrary, the present invention, while providing the user with a ticket to an event, also provides for engagement with the user, via the above-described bubbles. The platform further provides for the linking and sharing of memories of the event with other users.

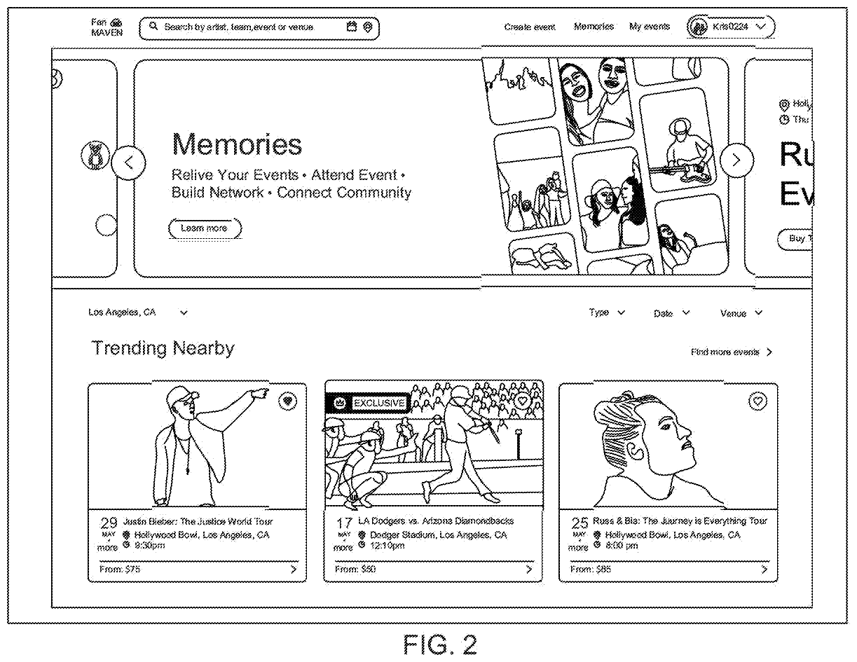

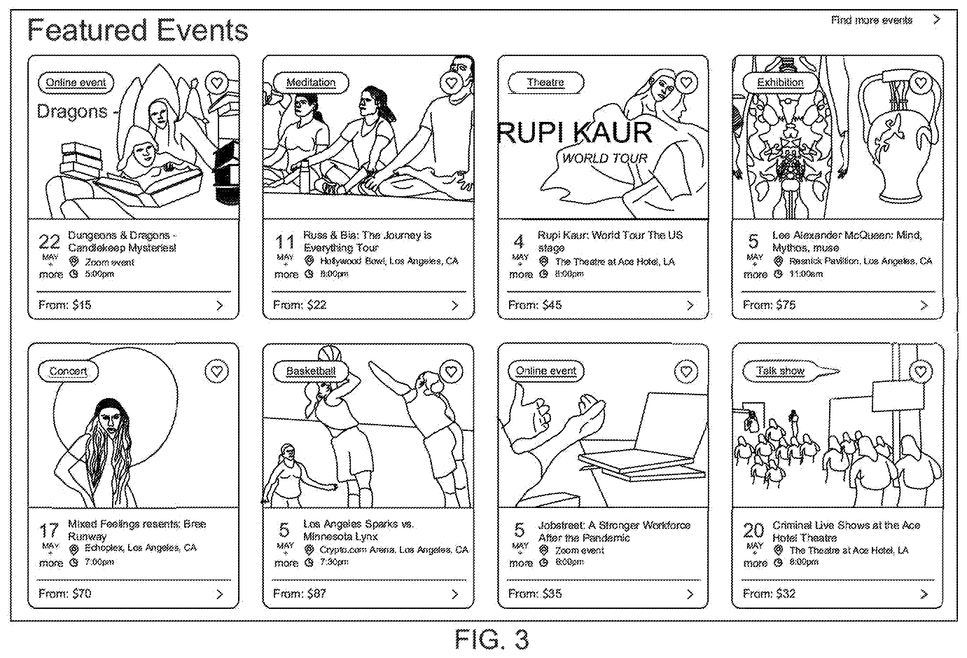

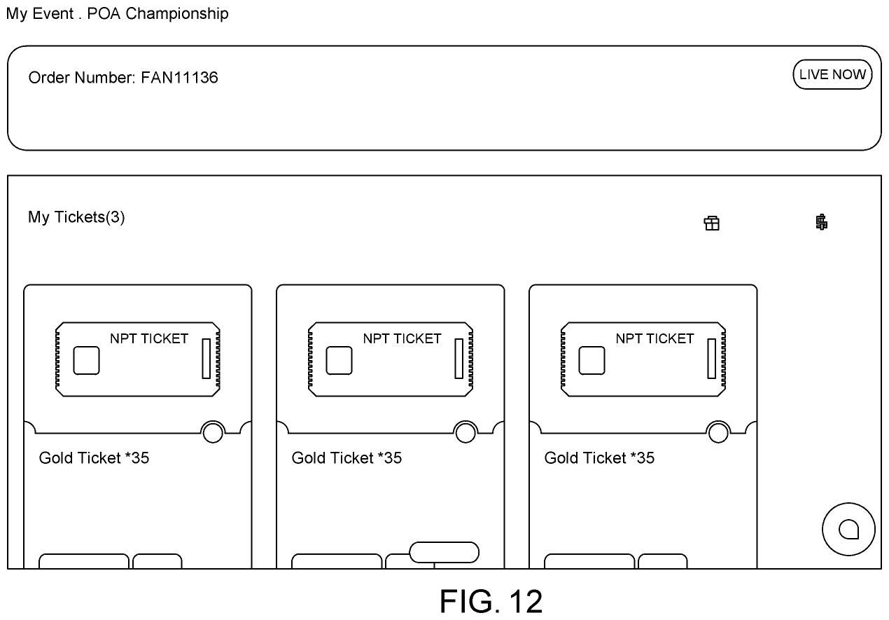

Referring now to FIGS. 2 and 3, an exemplary home page is shown for a user. The home page includes links to create an event, view memories, and view events of the user, such as past events and future events that the user has a ticket. FIG. 12 illustrates an example of a page showing NFT tickets the user has purchased. Such a view may be visible, for example, by clicking on the “my events” link on the user's home page. The home page can include a function to search for tickets which can be purchased on the platform.

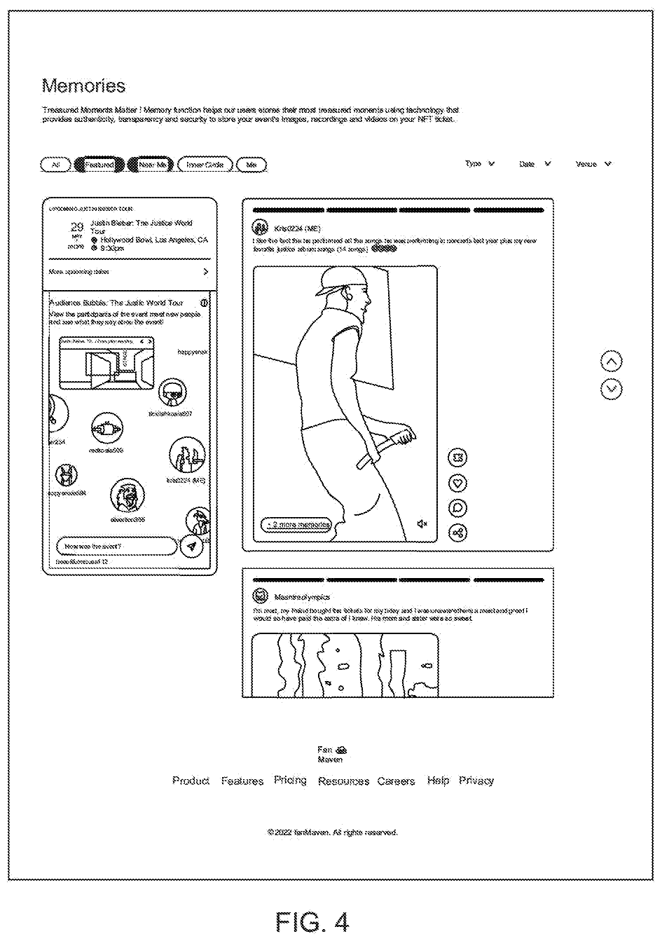

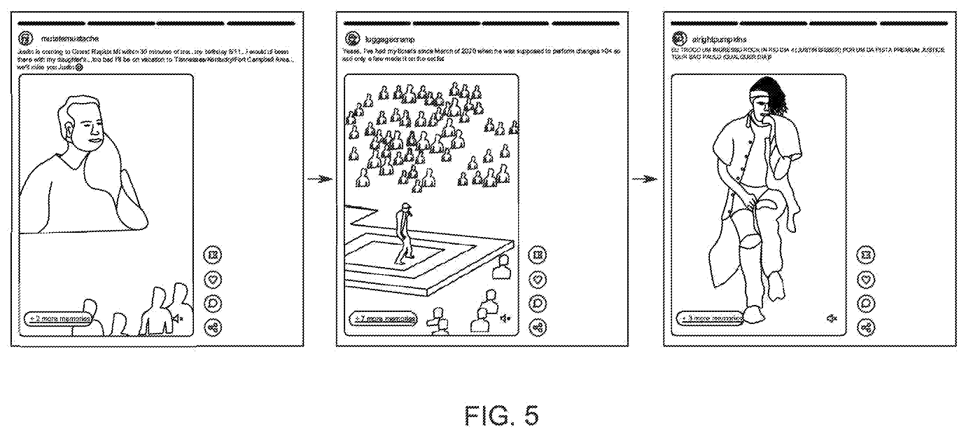

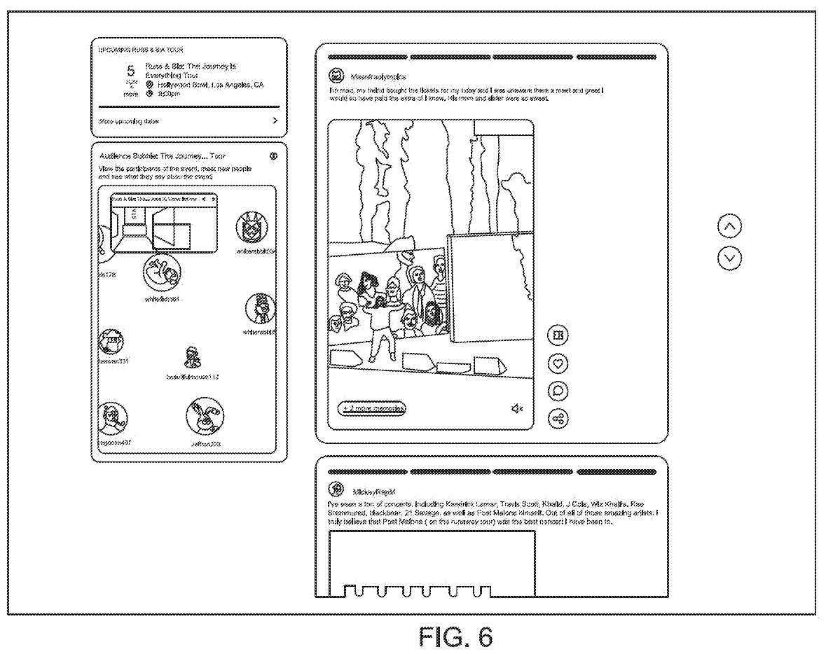

Referring to FIGS. 4 and 5, a user can click into memories from, for example, their home page, and land on a memory page, as illustrated in the exemplary screen show of FIG. 4. On this page, the memories can change, as shown in FIG. 5, after a predetermined period of time, such as every five seconds. As shown, each memory view can include the posting user's name as well as an optional comment added by the user. Scroll arrows, for example, of other similar means, such as keyboard entry, can also be used to scroll through memories. For example, clicking on the scroll arrow of FIG. 4 may provide the memory of a different event, as shown in FIG. 6. The user may have the option to select only their own memories, memories of nearby users, memories of selected user(s), featured memories, or the like.

The memories page can further provide the user with details of upcoming events of the memory being displayed. Further, the memory being displayed can provide the user with details of upcoming events of the same artist, similar genre, or the like. Such options are illustrated, for example, in FIGS. 4, 5 and 8, where the user may see and/or scroll through upcoming events. Thus, if a user is viewing another user's memory and they posted comments on how good the show is, the user can see an upcoming show date to purchase a ticket on the platform.

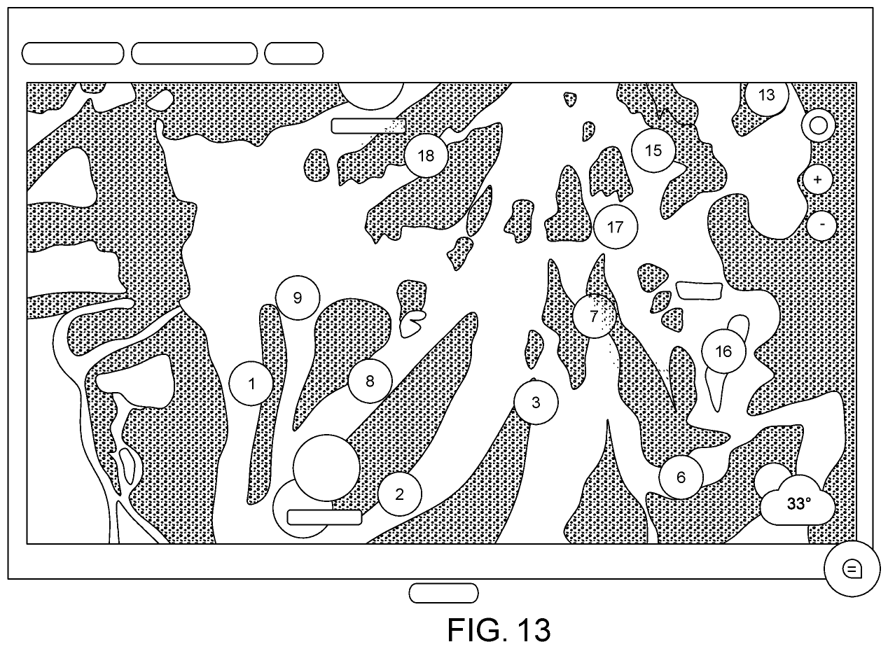

Further, as shown in FIG. 4, for example, engagement bubbles can be seen for the event being displayed. The user can scroll within the engagement bubbles to see a location in the venue and see users that are members of the platform. In some embodiments, a mini-map of the venue may be displayed, where a user can scroll through the mini-map and click into a location in the venue to view the participants in that particular area. The engagement bubbles can show location of users at a future event, at a past event, or even where users are at a live event. For example, FIG. 13 shows a mini-map of a golf course event, illustrating the users and permitting live, real time interaction therewith during the event. A comment box is provided to the user if the user attended the event. The bubbles may include, for example, a username and an avatar for each user. In some embodiments, the size of the engagement bubble can get larger as users gain more levels on the platform by, for example, attending more events, posting more memories, sharing more memories, or the like.

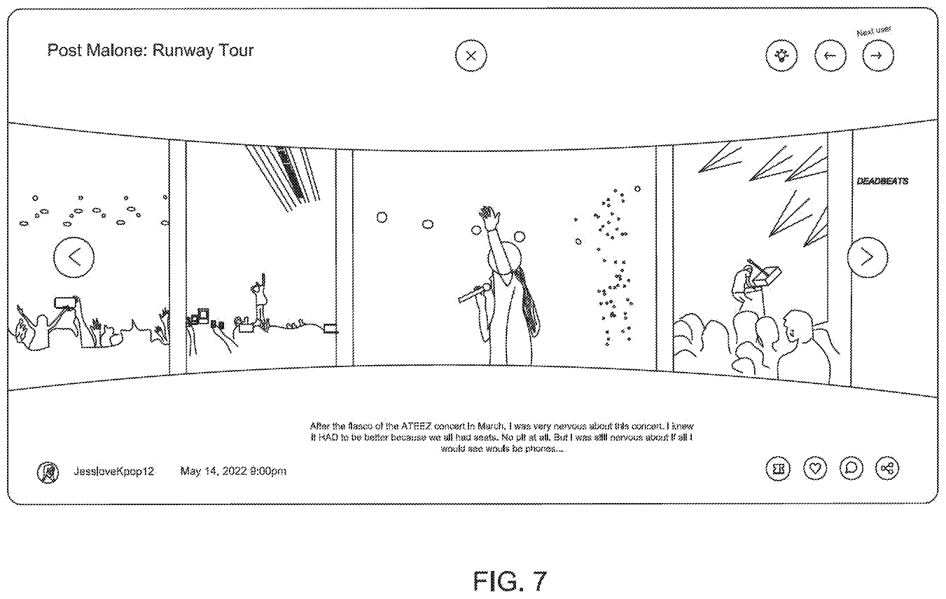

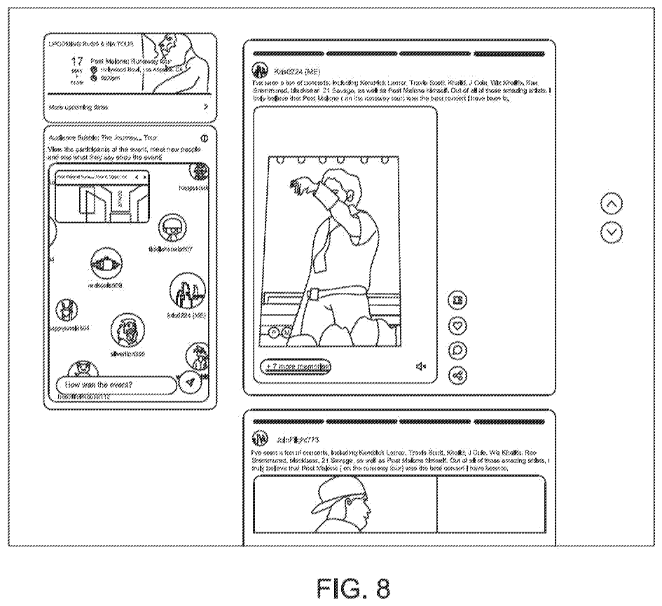

Referring now to FIGS. 7 and 8, when a user has multiple memories associated with an event, the first memory, such as the first photo or video, may include an indication of how many more are available to view by this particular user. As shown in FIG. 7, this memory by this particular user (in this case, the user is the person signed into the platform) includes seven additional memories. By clicking into this display, a user may be provided with a view to scroll through all the memories of this user for this particular event. An exemplary view that may be displayed by clicking on the “+7 more memories” box is shown in FIG. 8.

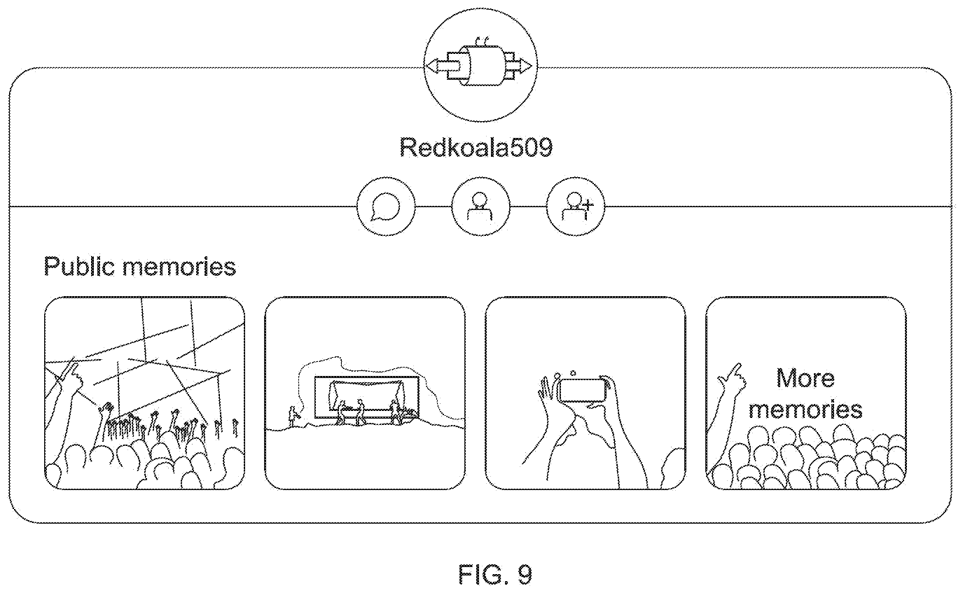

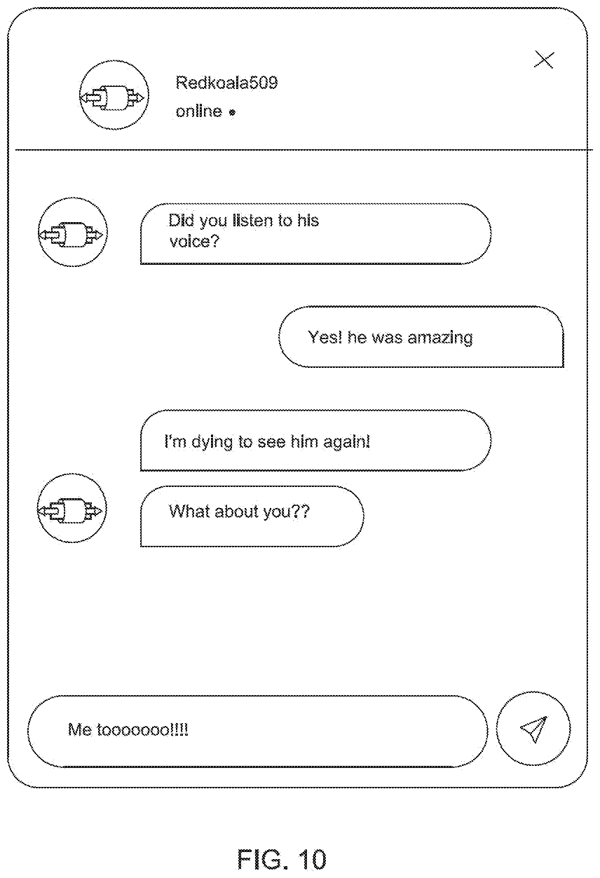

As with other memory pages, the page of FIG. 7 includes an engagement bubbles portion, where users that were part of the event are shown. If a user clicks on one of these bubbles, a display, as shown in FIG. 9, for example, is provided. In this display (which may be configured as a pop-up display, for example, on the open memory window), a simple profile of the user may be displayed. From this display, a user can click into a chat function to provide a private messaging system between the user and the user of the selected profile. Such a chat window is illustrated in FIG. 10.

As discussed above, the home page may include a link to the user's events. From here, the user can click into a past event and may interact with engagement bubbles to discuss the past show or view memories from the other users. Further, the user may see their current and future events. Similarly, the user may interact with users with live events or future events by chatting with the users or locating the users in the event center hosting the event. In some embodiments, during live events, a user may be able to interact, in real time, via the engagement bubbles, with other users at the same event.

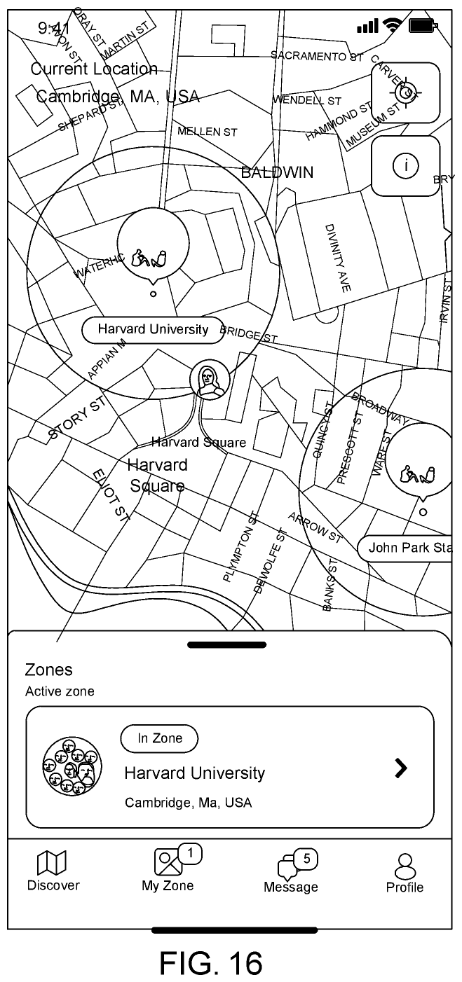

Referring now to FIG. 16, the user may view a map showing their location and the location of geo-fenced communities, or zones, in which they are located and also those geo-fenced communities nearby. For example, in FIG. 16, the map shows the within the zone of Harvard University. The user may go into the community they are located to initiate geo-fenced chat and media, such as photos, videos, live streams, and the like. The geo-fenced communities can include venues and public spaces, such as sporting events, conferences, trade shows, concerts, shows, festivals, private events, classes, landmarks, malls and the like.

In some embodiments, only users within a geo-fenced community may be authorized to post and/or read media, for example. In other embodiments, users outside a geo-fenced community may have access to certain features or all the features of the community. In some embodiments, a community moderator may be assigned to set the permission levels for users that are within or outside the geo-fenced community. In some embodiments, the community moderator may set up a private community, where users would be required to be granted access to the features of the community (such as posting messages, photos, videos, or the like). In this embodiment, when the user enters the community, a request permission button may appear so that the community moderator may be sent a message that a specific user requests access. In some embodiments, the private communities may be visible only to certain users, while, in other embodiments, the private communities may be visible to all users, but post/read permissions may be required to see and/or post any media thereto. In some embodiments, a password may be required to enter and/or access the private communities.

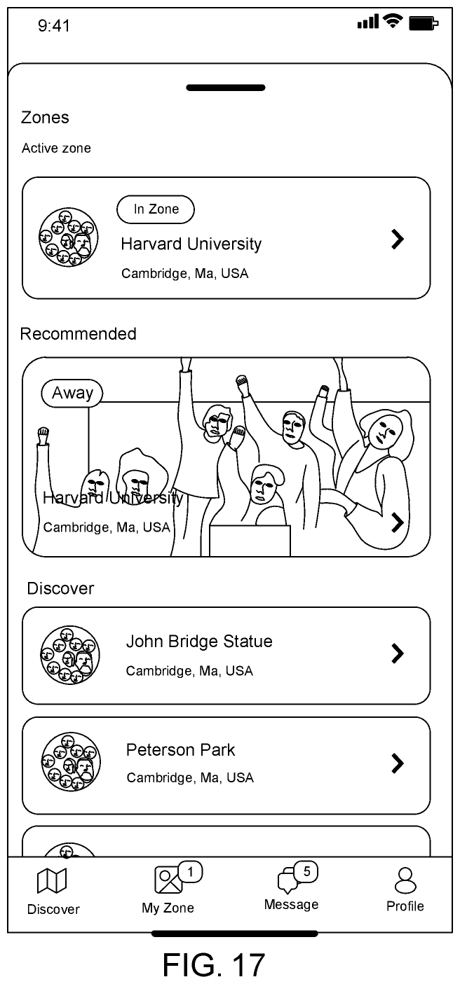

FIG. 17 shows an exemplary screen shot of a discover zones feature of the present invention. Here, the user may see recommended and nearby zones. The user may click into the zones to see the information about the zone for which they have permission. For example, a user that purchases a concert ticket may have access to the zone for the venue of the concert, allowing users to chat, send and share photos or videos, live streams or the like, with each other while at the venue, before the event, or after the event. Such a concert venue may show up as a recommended zone in the user's discover page after a ticket for an event is purchased, allowing the user easy access to the community.

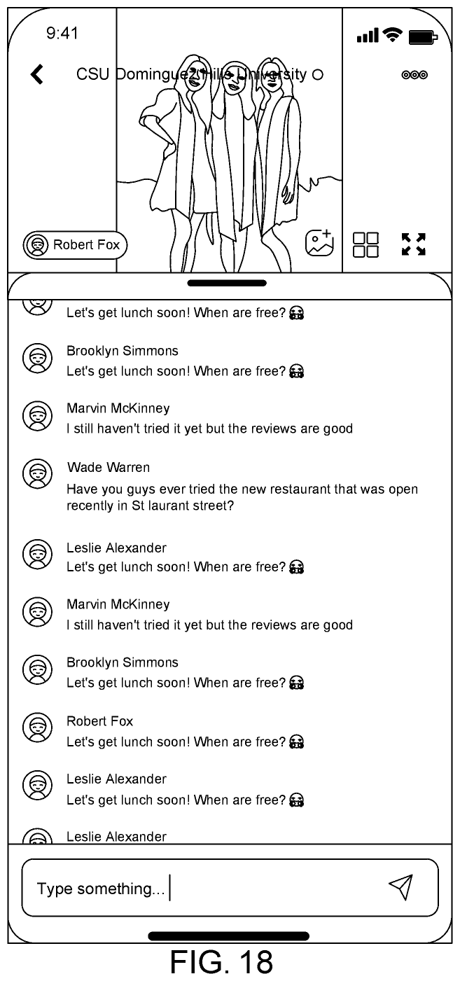

FIG. 18 shows an exemplary chat system that may be accessed when a user clicks into a certain community or zone. The chat system may allow users to exchange text messages, videos, photos, live streams or the like.

It should be understood that the Figures provide exemplary displays that may be provided in the platform of the present invention. The configuration of the display or the particular elements of the display may vary, and such illustrations are not meant to limit the invention, as described by the below claims, in any way.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Claim elements and steps herein may have been numbered and/or lettered solely as an aid in readability and understanding. Any such numbering and lettering in itself is not intended to and should not be taken to indicate the ordering of elements and/or steps in the claims.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different ones of the disclosed elements.

The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what incorporates the essential idea of the invention.

What is claimed is:

1. A computer-based platform for providing a user with interaction with events, other users and memories of past events, the platform permitting a user to perform functions comprising:
viewing a memories page of (1) a future event for which the user has purchased a ticket, (2) a past event for which the user has attended, or (3) a live event the user is in attendance, the memory page including engagement bubbles, the engagement bubbles identifying other users that (1) are attending the future event, (2) have attended the past event, or (3) are currently attending the live event, the memories page including media taken by the user or by the other users of the past event or of the live event;
viewing a user profile by clicking on a user displayed in the engagement bubbles; and
providing a messaging function by clicking on a chat icon displayed in the user profile.

2. The computer-based platform of claim 1, wherein the user can perform the function of purchasing a ticket.

3. The computer-based platform of claim 1, wherein the user can perform the function of linking media of an attended event to a ticket purchased to the event.

4. The computer-based platform of claim 3, wherein the user can perform the function of receiving memorabilia of the attended event and saving the memorabilia to the memories page of the user for the attended event.

5. The computer-based platform of claim 4, wherein the memorabilia includes at least one of a proof of attendance from an event organizer and an overlay memorabilia for overlaying upon a user-saved memory from the event.

6. The computer-based platform of claim 4, wherein an event organizer can perform the function of electronically delivering memorabilia to at least a portion of attendees at an event.

7. The computer-based platform of claim 1, wherein the user can perform the function of automatically scrolling through memories of a selected event of each of a plurality of attendees of the selected event.

8. The computer-based platform of claim 1, wherein the user can perform the function of scrolling between different events.

9. The computer-based platform of claim 1, wherein the user can perform the function of viewing suggested events based on past memories and past events saved by the user.

10. The computer-based platform of claim 1, wherein the user can perform the function of scrolling through the engagement bubbles while viewing a location of displayed engagement bubbles within an event location.

11. A computer-based platform for providing a user with interaction with events, other users and memories of past events, the platform permitting a user to perform functions comprising:
viewing one or more geo-fenced areas on a map, the one or more geo-fenced areas corresponding to a defined location on the map;
permitting the user to post or view live or recorded media related to a selected one of the one or more geo-fenced areas, wherein the media includes text, photos, videos or live streams; and
regulating access to media within the selected one of the geo-fenced areas based on at least one of a geolocation of the user or a predetermined permission for the selected one of the geo-fenced areas.

12. The computer-based platform of claim 11, wherein the one or more areas are of (1) a future event for which the user has purchased a ticket, (2) a past event for which the user has attended, or (3) a live event the user is in attendance, the one or more geo-fenced zones identifying other users that (1) are attending the future event, (2) have attended the past event, or (3) are currently attending the live event, the one or more geo-fenced areas including media taken by the user or by the other users of the past event or of the live event.

13. The computer-based platform of claim 11, further comprising displaying, to the user, other users that are within the selected one of the one or more geo-fenced areas.

14. The computer-based platform of claim 12, further comprising:
linking media of an attended event to a ticket purchased to the attended event; and
receiving memorabilia of the attended event and saving the memorabilia to a profile of the user for the attended event.

15. The computer-based platform of claim 11, wherein the user can perform the function of linking media of an event to a ticket purchased to the event.

16. The computer-based platform of claim 11, wherein the user can perform the function of purchasing a ticket.

17. The computer-based platform of claim 11, wherein the user can perform the function of automatically scrolling through memories of a selected event of each of a plurality of attendees of the selected event.

18. The computer-based platform of claim 11, wherein the user can perform the function of scrolling between different events.

19. The computer-based platform of claim 11, wherein the user can perform the function of viewing suggested events based on past memories saved by the user or on past attended events.

20. A computer-based platform for providing a user with interaction with events, other users and memories of past events, the platform permitting a user to perform functions comprising:
listing future events and permitting a user to purchase a ticket to a selected one of the future events;
viewing a memories page of (1) a future event for which the user has purchased a ticket, (2) a past event for which the user has attended, or (3) a live event the user is in attendance, the memory page including engagement bubbles, the engagement bubbles identifying other users that (1) are attending the future event, (2) have attended the past event, or (3) are currently attending the live event, the memories page including media taken by the user or by the other users of the past event or of the live event;
linking media of an attended event to a ticket purchased to the event;
receiving a memorabilia of the attended event and saving the memorabilia to the memories page of the user for the attended event;
viewing a user profile by clicking on a user displayed in the engagement bubbles; and
providing a messaging function by clicking on a chat icon displayed in the user profile.
